(19) United States
(12) Patent Application Publication
(10) Pub. No.: US 2025/0202330 A1
(43) Pub. Date: Jun. 19, 2025

(54) PERFORMANCE DETECTION SYSTEM FOR ROTATING DEVICE AND PERFORMANCE DETECTION METHOD THEREOF

(71) Applicant: Aktiebolaget SKF, Göteborg (SE)

(72) Inventors: Xing YI, Shanghai (CN); Xiaoyuan MA, Shanghai (CN); Hongwei WU, Shanghai (CN); Liang ZHANG, Zou Cheng (CN); Chenguang WANG, Shanghai (CN); Ying ZHU, Shanghai (CN)

(21) Appl. No.: 18/975,948

(22) Filed: Dec. 10, 2024

(30) Foreign Application Priority Data
Dec. 18, 2023 (CN) 202311749302.4

(51) Int. Cl. H02K 35/02; H04W 4/38

(52) U.S. Cl. CPC H02K 35/02; H04W 4/38

(57) ABSTRACT

A performance detection system for the rotating device and a performance detection method for the rotating device are disclosed. The system includes a passive detection device and a gateway device. The passive detection device converts vibration energy from the rotating device into electrical energy to supply power to the passive detection device. The passive detection device transmits a broadcast signal frame to a gateway device in a preset broadcast period when the electrical energy is greater than a preset electrical energy threshold. The gateway device receives the broadcast signal frame from the passive detection device and determines a performance state of the rotating device based on the broadcast signal frame.

### CROSS-REFERENCE TO RELATED APPLICATION

This application claims priority to Chinese Application No. 202311749302.4, filed Dec. 18, 2023, the entirety of which is hereby incorporated by reference.

### FIELD

The present disclosure relates to the field of detection, and more specifically to a performance detection system for a rotating device and a performance detection method for the rotating device.

### BACKGROUND

With the wide application of detection technology in civil and commercial fields, detection systems, especially performance detection systems for the rotating device, are also facing higher requirements.

Sensor devices are usually provided in current performance detection systems, and the sensors generally include two types: wired sensors and battery-based wireless sensors. For wired sensors, installation is inconvenient due to the need for special wiring to connect to an external independent power source. Although battery-based wireless sensors can solve the wiring problem, they involve another problem. The life of the battery is limited (usually 3-5 years), and there are electrical losses, which require occasional replacement of the battery or replacement of a new sensor.

Therefore, on the premise of achieving good performance detection of the rotating device, there is a need for a detection device in the detection system that does not require complex wiring to achieve power supply, nor does it need to consider the problem of battery exhaustion and replacement, and the detection system can be implemented via a simple and convenient judgment logic to implement the reliable detection of the performance state of the rotating device.

### SUMMARY

In view of the above problems, the present disclosure provides a performance detection system for the rotating device and a performance detection method for the rotating device. Utilizing the performance detection system and performance detection method provided by the present disclosure, on the basis of achieving good performance detection of the rotating device, the detection device in the system can realize self-power supply through energy conversion without the need to additionally set up an external power supply. In addition, the detection system can realize reliable detection of the performance state of the rotating device by simple and convenient judgment logic.

According to an aspect of the present disclosure, a performance detection system for the rotating device is provided, comprising: a passive detection device configured to convert vibration energy from the rotating device into electrical energy to supply power to the passive detection device, and the passive detection device is configured to transmit a broadcast signal frame to a gateway device in a preset broadcast period when the electrical energy is greater than a preset electrical energy threshold; and the gateway device configured to receive the broadcast signal frame from the passive detection device and determine a performance state of the rotating device based on the broadcast signal frame.

In some embodiments, the passive detection device comprises an energy collection module installed on a body of the rotating device and configured to convert the collected vibration energy from the rotating device into alternating current energy, a power management module configured to receive the alternating current energy from the energy collection module and convert the alternating current energy to direct current energy, and a communication module configured to transmit the broadcast signal frame in the preset broadcast period after being powered on; wherein the power management module is configured to supply power to the communication module when the direct current energy is greater than a preset direct current energy threshold, and cause the communication module to power off when the direct current energy is lower than the preset direct current energy threshold.

In some embodiments, the broadcast signal frame includes identifier information of the passive detection device and current frame number information; wherein the current frame number information increases as the transmission times of the broadcast signal frame increase.

In some embodiments, at least part of the content in the broadcast signal frame is encrypted, and the gateway device performs corresponding decryption processing after receiving the broadcast signal frame.

In some embodiments, the gateway device comprises a wireless communication module configured to receive the broadcast signal frame from the passive detection device, and a control module configured to determine the performance state of the rotating device based on the broadcast signal frame.

In some embodiments, the control module is configured to: determine a total number of frames in a current detection period based on the broadcast signal frame, wherein a duration of the current detection period is greater than a duration of the preset broadcast period; and compare the total number of frames to a total-frame-number threshold, and determine the performance state of the rotating device to be a normal state if the total number of frames is less than or equal to the total-frame-number threshold.

In some embodiments, in a case that the total number of frames is greater than the total-frame-number threshold, the control module is further configured to: obtain a total number of frames of a detection period immediately preceding the current detection period and determine it as a previous total number of frames; determine a difference between the total number of frames and the previous total number of frames; and compare the difference to a difference threshold and determine the performance state of the rotating device based on the comparison.

In some embodiments, the control module is configured to determine the performance state of the rotating device as a slightly abnormal state if the difference is less than or equal to the difference threshold; and determine the performance state of the rotating device as a severely abnormal state if the difference is greater than the difference threshold.

In some embodiments, the total-frame-number threshold and the difference threshold are automatically generated based on a machine learning process.

In some embodiments, the system further includes an external device, the external device includes at least one of a cloud platform and a user device; wherein the gateway device is further configured to transmit the performance state of the rotating device to the external device, and the external device is configured to receive the performance state from the rotating device and perform a corresponding operation based on the performance state of the rotating device.

In accordance with another aspect of the present disclosure, a performance detection method for the rotating device is provided, which comprises: converting, via a passive detection device, vibration energy from the rotating device into electrical energy to supply power to the passive detection device; transmitting, via the passive detection device, a broadcast signal frame to a gateway device in a preset broadcast period when the electrical energy is greater than a preset electrical energy threshold; and receiving, via the gateway device, the broadcast signal frame from the passive detection device and determining a performance state of the rotating device based on the broadcast signal frame.

In some embodiments, the converting the vibration energy from the rotating device into the electrical energy via the passive detection device to supply power to the passive detection device comprises: converting, via an energy collection module installed on the body of the rotating device, the collected vibration energy from the rotating device into alternating current energy; receiving, via a power management module, the alternating current energy from the energy collection module and converting the alternating current energy into direct current energy.

In some embodiments, the transmitting the broadcast signal frame via the passive detection device to the gateway device in the preset broadcast period when the electrical energy is greater than the preset electrical energy threshold comprises: transmitting the broadcast signal frame, via a communication module being powered on, in the preset broadcast period; and wherein the communication module is powered on, via the power management module, when the direct current energy is greater than a preset direct current energy threshold; the communication module is powered off, via the power management module, when the direct current energy is lower than the preset direct current energy threshold.

### BRIEF DESCRIPTION OF DRAWINGS

In order to explain the technical solutions of the embodiments of the present disclosure more clearly, the drawings needed to be used in the description of the embodiments will be briefly introduced below. Obviously, the drawings in the following description are only some embodiments of the present disclosure. For those of ordinary skill in the art, other drawings can be obtained based on these drawings without creative efforts. The following drawings are not intended to scale to actual dimensions, with emphasis being placed on illustrating the gist of the present disclosure.

FIG. 1 illustrates a schematic diagram of a performance detection system 100 for the rotating device according to an embodiment of the present disclosure;

FIG. 2 illustrates a schematic diagram of a passive detection device 110 according to an embodiment of the present disclosure;

FIG. 3 illustrates a schematic diagram of the frame format of a broadcast signal frame according to an embodiment of the present disclosure;

FIG. 4 illustrates a schematic diagram of a gateway device 120 according to an embodiment of the present disclosure;

FIG. 5 illustrates an example flowchart of a process 200 for determining the performance state of the rotating device based on the broadcast signal frames according to an embodiment of the present disclosure;

FIG. 6 illustrates an exemplary flowchart of a performance detection method 300 for the rotating device according to an embodiment of the present disclosure; and

FIG. 7 illustrates an exemplary flowchart of a process S301 of converting the vibration energy from the rotating device into the electrical energy according to an embodiment of the present disclosure.

### DETAILED DESCRIPTION

The technical solutions in the embodiments of the present disclosure will be clearly and completely described below with reference to the accompanying drawings. Obviously, the described embodiments are only some of the embodiments of the present disclosure, not all of the embodiments. Based on the embodiments of the present disclosure, all other embodiments obtained by those of ordinary skill in the art without creative efforts also fall within the scope of protection of the present disclosure.

As used in this application and claims, the words “a,” “an,” and/or “the” do not specifically refer to the singular and may include the plural unless the context clearly indicates an exception. In general, the terms “comprises” and “comprising” only imply the inclusion of the steps or elements specifically identified and do not constitute an exclusive list and a method or apparatus may contain additional steps or elements.

Although the present application makes various references to certain modules in systems according to embodiments of the present application, any number of different modules may be used and run on user terminals and/or servers. The modules are illustrative only, and different aspects of the systems and methods may use different modules.

Flowcharts are used in this application to illustrate operations performed by systems according to embodiments of the present application. It should be understood that the preceding or following operations are not necessarily performed exactly in order. Rather, the various steps may be processed in reverse order or simultaneously, as desired. At the same time, other operations can also be added to these processes, or a certain step or steps can be removed from these processes.

According to an aspect of the present disclosure, a performance detection system 100 for the rotating device is provided. It should be understood that the performance detection system refers to a system for realizing a detection of the operating performance of the rotating device. The rotating device may be, for example, a motor shaft, a machine tool shaft, or other equipment that rotates around its own rotation axis under normal working conditions. Embodiments of the present disclosure are not limited by the specific type of the rotating device and its specific elements.

FIG. 1 shows a schematic diagram of the performance detection system 100 for the rotating device according to an embodiment of the present disclosure.

Referring to FIG. 1, the performance detection system 100 may include, for example, a passive detection device 110 and a gateway device 120.

The passive detection device 110 refers to a detection device that can achieve good self-power through energy conversion without an additional external power supply. For example, the passive detection device 110 is configured to convert vibration energy from a rotating device into electrical energy to power the passive detection device.

The passive detection device 110 is configured to transmit a broadcast signal frame to the gateway device in a preset broadcast period when the electrical energy is greater than a preset electrical energy threshold.

It should be understood that the passive detection device may, for example, first convert the vibration energy into alternating current electrical energy, and then further convert the alternating current electrical energy into direct current electrical energy. Therefore, the preset electrical energy may, for example, be a preset direct current electrical energy. However, it should be understood that embodiments of the present disclosure are not limited thereto.

By setting the passive detection device 110 to transmit broadcast signal frames to the gateway device in a preset broadcast period when the electrical energy is greater than a preset electrical energy threshold, the number of broadcast signal frames sent by the passive detection device is positively correlated with the electrical energy converted by the passive detection device, that is, positively correlated with the vibration energy of the rotating device (which reflects the current vibration state of the rotating device), thereby enabling the performance state of the rotating device to be determined based on the processing of the broadcast signal frame.

It should be understood that the preset electrical energy threshold may be, for example, set by the user, or may also be a parameter value preset by the system. Embodiments of the present disclosure are not limited thereto.

The passive detection device 110 may, for example, transmit the broadcast signal frame to the gateway device 120 via a short-range wireless communication method, such as communicating with the gateway via a short-range low-power method such as BLE, Sub G, LoRa, ZigBee, etc. It should be understood that embodiments of the present disclosure are not limited by the specific communication method.

Furthermore, the passive detection device 110 may communicate with the gateway device, for example by broadcasting. The preset broadcast period refers to a preset period in which the passive detection device transmits broadcast information. For example, in the broadcast communication mode, in order to avoid communication conflicts, the preset broadcast period may be, for example, a constant period value superimposed with a delay value floating within a preset range to improve the transmission and reception reliability of broadcast communications. However, it should be understood that embodiments of the present disclosure are not limited thereto.

The broadcast signal frame characterizes data information sent by the passive detection device 110 to the gateway device 120. For example, the broadcast signal frame may have a preset frame format. For example, the broadcast signal frame may be set to have an ID field and a frame number value field. The identifier information of the passive detection device is stored in the ID field, and the current frame number information is stored in the frame number value field. However, it should be understood that embodiments of the present disclosure are not limited thereto.

The gateway device 120 is configured to receive the broadcast signal frame from the passive detection device 110 and determine the performance state of the rotating device based on the broadcast signal frame.

It will be appreciated that the gateway device may, for example, be configured to integrate a plurality of broadcast signal frames from the passive detection device 110 and determine the performance state of the rotating device based on the results of the processing.

Based on the above, in this application, by setting up the performance detection system for the rotating device to include a passive detection device and a gateway device, and setting up the passive detection device to convert vibration energy from the rotating device into electrical energy to provide power to the passive detection device, the detection device in the performance detection system in this application does not need complicated wiring to achieve power supply, nor does it need to consider the problem of battery exhaustion and replacement, thereby achieving self-power in a simple and convenient manner through energy conversion and simplifying the overall settings of the performance detection system. In addition, by transmitting a broadcast signal frame to the gateway apparatus in a preset broadcast period when the electrical energy is larger than a preset electrical energy threshold so that the number of broadcast signal frames sent by the passive detection device is positively correlated with the electrical energy (that is, correlated with the vibration state of the rotating device) converted by the passive detection device, and by further setting the gateway device to receive the broadcast signal frames from the passive detection device and determine the performance state of the rotating device based on the broadcast signal frames, the performance state detection of the rotating device can be realized in a simple and convenient manner through the cooperation of the passive detection device and the gateway device. There is no need to set up a separate dedicated detection sensor or sensing circuit. It takes into account the performance detection of the rotating device while realizing the self-power supply of the detection device, further simplifies the system structure, and improves the reliability and robustness of the performance detection system.

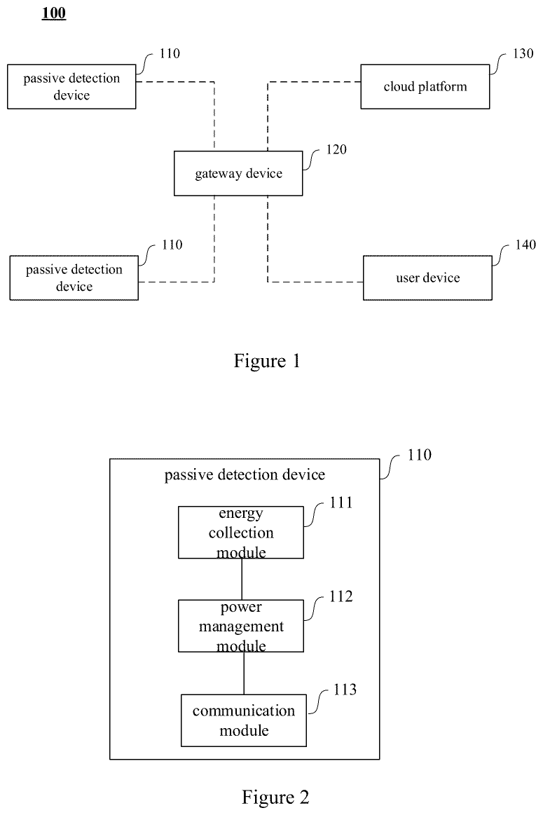

FIG. 2 shows a schematic diagram of a passive detection device 110 according to an embodiment of the present disclosure. Referring to FIG. 2, in some embodiments, the passive detection device 110 includes, for example, an energy collection module 111, a power management module 112 and a communication module 113.

The energy collection module 111 is intended to realize the conversion process of vibration energy into electrical energy. For example, the energy collection module 111 may be installed, for example, on the body of the rotating device and configured to convert the collected vibration energy from the rotating device into alternating current energy.

For example, when the rotating device is a motor, the energy collection module 111 can be installed on the bearing bracket of the main shaft of the motor, or at the heat sink of the motor, to better collect the vibration energy of the motor.

For example, the energy collection module may be, for example, a piezoelectric transducer, a magnetoelectric transducer, or a triboelectric transducer to convert vibration energy from the rotating device into alternating current energy based on piezoelectric/magnetoelectric/triboelectric conversion.

However, it should be understood that depending on the actual situation, other structures, components or types of transducers may be selected to achieve the conversion of vibration energy into alternating current energy. It should be understood that the embodiments of the present disclosure are not limited by the specific energy conversion method and the specific type of transduction component.

The power management module 112 is configured to receive the alternating current energy from the energy collection module 111, convert the alternating current energy into direct current energy, and supply power to at least some modules in the passive detection device 100 based on the direct current energy.

It should be understood that the power management module may, for example, rectify the alternating current energy obtained in the energy collection module based on a rectifier module to obtain direct current energy. The power management module can also be further provided with, for example, a regulator module, an energy tracking module, etc., to achieve further adjustment of the direct current energy and maximize the obtained electric power.

The power management module 112 is configured, for example, to supply power to the communication module 113 when the direct current electrical energy is greater than a preset direct current electrical energy threshold; and cause the communication module 113 to power off when the direct current energy is lower than the preset direct current energy threshold.

The preset direct current energy threshold represents a minimum direct current energy value that enables a good power supply to the communication module. It should be understood that the preset direct current energy threshold may be, for example, selected by the user, or may also be preset by the system, and embodiments of the present disclosure are not limited thereto.

The communication module 113 is configured to transmit broadcast signal frames in a preset broadcast period after being powered on.

For example, the preset direct current energy threshold is A. When the performance detection system is working, the energy collection unit provided on the main body of the rotating device will continuously convert vibration energy into the alternating current energy, and further convert the alternating current energy into direct current energy in the power management module. If the direct current energy Wc is greater than the preset direct current energy threshold A, the power management module will power the communication module at this time. For example, the communication module transmits broadcast signal frames in a broadcast period Tc. For example, after transmitting 20 broadcast signal frames, the direct current energy Wc is less than the direct current energy threshold A, then the communication module will be powered off at this time, and the communication module will no longer transmit broadcast signal frames. Until the next direct current energy Wc meets greater than the preset direct current energy threshold A, the system powers on the communication module again.

Based on the above, in this application, by setting the passive detection device to include an energy collection module, a power management module, and a communication module, the vibration energy collected from the rotating device can be converted into alternating current energy via the energy collection module, and the alternating current energy can be converted into direct current energy via the power management module, thereby achieving a good self-power supply for the passive detection device. In addition, by setting that the communication module is powered on when the direct current electrical energy is greater than a preset direct current electrical energy threshold and the communication module is powered off when the direct current electrical energy is lower than the preset direct current electrical energy threshold, and the communication module is allowed to transmit broadcast signal frames in a preset broadcast period after being powered on, so that the communication module can be powered on when the power reaches a predetermined level and the communication module transmits a corresponding broadcast signal frame, thereby facilitating subsequent determination of the performance state of the rotating device based on the broadcast signal frame.

In some embodiments, the broadcast signal frame includes identifier information of the passive detection device and current frame number information.

The identifier information of the passive detection device 110 refers to information used to represent the passive detection device, which may be, for example, a universal Unique Identifier (UUID) of the passive detection device, or may also be other identifiers characterizing the passive detection device. Embodiments of the present disclosure are not limited by the composition of the identifier information.

By transmitting the identifier information of the passive detection device in the broadcast signal frame, the current passive detection device corresponding to the broadcast signal frame and the corresponding rotating device can be determined simply and conveniently, even if there are multiple passive detection devices in the system (for example, respectively detecting the performance state of different rotating devices).

The current frame number information is intended to represent the total number of currently sent broadcast signal frames. The current frame number information may be, for example, in the form of 10-bit binary encoding, or may also be in other forms. Embodiments of the present disclosure are not limited thereto. The current frame number information increases with the increase of the transmission times of the broadcast signal frame.

It should be understood that, according to actual needs, the broadcast signal frame may also have, for example, encrypted verification information, which is obtained by processing core data (such as current frame number information) with a specific verification algorithm. At this time, after the gateway device receives the core data, for example, the core data will be calculated through the same verification algorithm to obtain new encrypted verification information, and the new encrypted verification information will be compared with the encrypted verification information contained in the broadcast signal frame to avoid the situation where the broadcast signal frame is changed by interference or attacks during transmission.

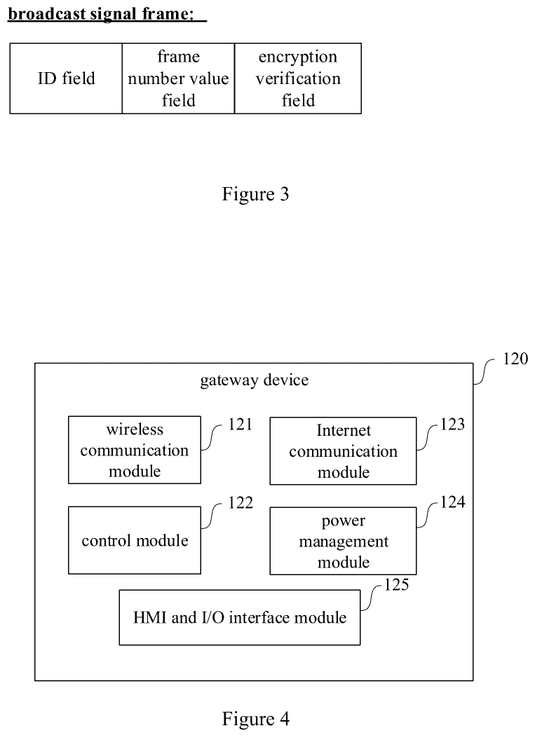

Next, the broadcast signal frame will be described in more detail with reference to specific embodiments. FIG. 3 shows a schematic diagram of the frame format of a broadcast signal frame according to an embodiment of the present disclosure. Referring to FIG. 3, the broadcast signal frame can be set to have, for example, an ID field, a frame number value field, and an encryption verification field. For example, identifier information of the passive detection device is stored in the ID field, current frame number information is stored in the frame number value field, and encryption verification information is stored in the encryption verification field.

The ID field may be, for example, in the form of 32-bit binary encoding, and the frame number value field and the cryptographic check field may be, for example, in the form of 16-bit binary encoding. Each time a broadcast signal frame is transmitted, the value of the frame number value field is incremented, for example, by one compared to the previous time, and is automatically zeroed back when it reaches 65536.

Based on the above, in this application, by setting the broadcast signal frame to include the identifier information of the passive detection device and the current frame number information, and setting the current frame number information to increase with the increase of the transmission times of the broadcast signal frame, the passive detection device that sent the broadcast signal frame can be reliably determined based on the broadcast signal frame, and at the same time, the total number of broadcast signal frames (current frame number information) that has been sent at present can be determined, so that subsequent processing can be well performed based on the current frame number information to determine the performance state of the corresponding rotating device.

In some embodiments, at least part of the content in the broadcast signal frame is encrypted, and the gateway device performs corresponding decryption processing after receiving the broadcast signal frame.

It should be understood that the encryption process may be, for example, an encryption process by appending an additional encryption check field as described above, or it may also be to encrypt the entire broadcast signal frame and then transmit the encrypted data content. It should be understood that the embodiments of the present disclosure are not limited by the encryption process and encryption method.

Based on the above, in this application, at least part of the content in the broadcast signal frame is encrypted, and the gateway device performs corresponding decryption processing after receiving the broadcast signal frame, so that the reliability and security of the communication transmission can be further improved on the basis of realizing good communication.

FIG. 4 shows a schematic diagram of a gateway device according to an embodiment of the present disclosure. Referring to FIG. 4, in some embodiments, the gateway device 120 includes a wireless communication module 121 and a control module 122.

The wireless communication module 121 is configured to receive the broadcast signal frame from the passive detection device 110. It should be understood that the wireless communication module 121 may, for example, have multiple channels to simultaneously receive broadcast signal frames from multiple passive detection devices.

The control module 122 is configured to determine the performance state of the rotating device based on the broadcast signal frame, e.g., the control module 122 may determine the total number of frames in a current detection period based on the broadcast signal frame, compare the total number of frames to a total-frame-number threshold and determine a performance state of the rotating device based on the comparison. However, it should be understood that the above only gives an example, and embodiments of the present disclosure are not limited thereto.

It should be understood that according to actual needs, the gateway device 120 may further include, for example, an Internet communication module 123, a power management module 124, a Human Machine Interface (HMI) and input/output (I/O) interface module 125.

The Internet communication module 123 may, for example, follow communication protocols such as Ethernet/WIFI/4G to realize data interaction between the gateway device 120 and the cloud platform and user equipment (such as mobile terminals) in the performance detection system.

The power management module 124 is intended, for example, to provide adapted power to different sub-modules in the gateway device.

The human-machine interface and input-output interface module 125 is, for example, intended to provide an interface for the user to interact with the gateway device.

Based on the above, in this application, by setting the gateway device to include a wireless communication module and a control module, setting the wireless communication module to receive a broadcast signal frame from the passive detection device, and setting the control module to determine the performance state of the rotating device based on the broadcast signal frame, each functional module within the gateway device can be well set, thereby optimizing the functional layout of the gateway device and achieving good performance detection of the rotating device.

Next, for example, the execution process of the control module will be described in more detail.

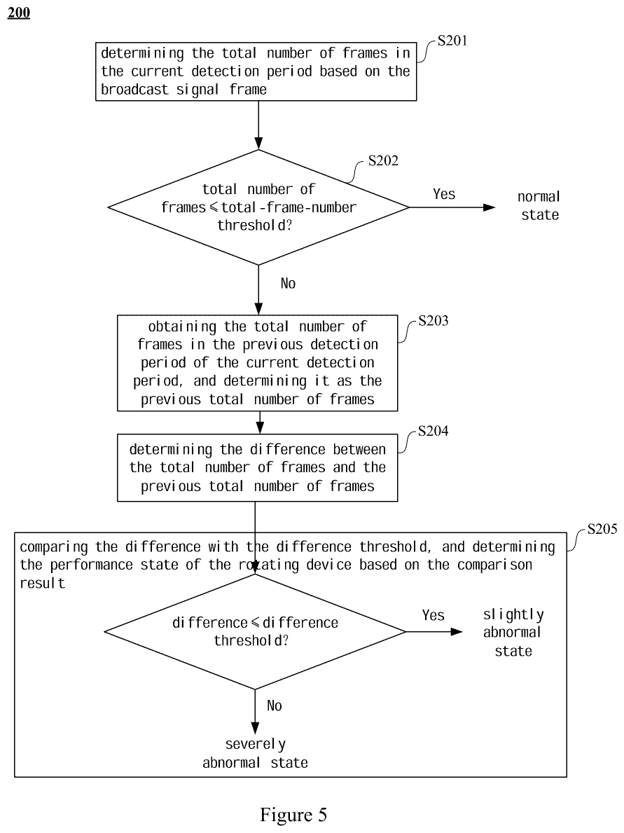

FIG. 5 illustrates an example flow diagram of process 200 for determining the performance state of the rotating device based on the broadcast signal frame in accordance with an embodiment of the present disclosure. Referring to FIG. 5, in some embodiments, the control module 122 is configured to first, in step S201, determine the total number of frames in the current detection period based on the broadcast signal frame.

The detection period refers to the period of detecting the rotating device, and the current detection period is the detection period in which the performance detection system is currently located. For example, it can be preset by the system or selected by the user. For example, the current detection period may be a value in the range of 0.5H (hour) to 24H, and it may be a multiple of 0.5H, for example. However, it should be understood that the above only gives an example of a current detection period.

It should be understood that the duration of the current detection period is greater than the duration of the preset broadcast period. For example, the duration of the current detection period is usually in units of hours, and the duration of the preset broadcast period is usually in units of ms.

The process of determining the total number of frames in the current detection period may include, for example, obtaining the current frame number information S1 of the first broadcast signal frame received in the current detection period and current frame number information S2 of the last broadcast signal frame received in the current detection period, and subtracting the current frame number information S2 of the last broadcast signal frame from the current frame number information S1 of the first broadcast signal frame to obtain the total number of frames of broadcast signal frames in the current detection period.

Thereafter, in step S202, the total number of frames is compared with a total-frame-number threshold, and if the total number of frames is less than or equal to the total-frame-number threshold, the performance state of the rotating device is determined to be a normal state.

The total-frame-number threshold refers to a data value used to represent the upper limit of the total number of frames. Exceeding the threshold reflects that there are too many broadcast signal frames in the current detection period, because the number of broadcast signal frames is strongly related to the vibration state (vibration amplitude, vibration intensity and vibration frequency) of the rotating device, that is, it reflects that the vibration state of the rotating device is abnormal in the current detection period.

It should be understood that the total-frame-number threshold may be preset, for example, or may be selected by the user, or may be automatically generated via machine learning, such as by a neural network algorithm. Embodiments of the present disclosure are not limited thereto.

The normal state means that the rotating device is in a normal operating and working state. For example, it can indicate that the vibration state of the rotating device is within a preset range and does not affect the normal use of the rotating device.

Based on the above, in this application, the gateway device is configured to determine the total number of frames in the current detection period based on the broadcast signal frame, and compare the total number of frames with a total-frame-number threshold. If the total number of frames is less than or equal to the total-frame-number threshold, the performance state of the rotating device is determined as a normal state, thereby the performance state of the rotating device can be determined in a simple and convenient manner based on broadcast signal frames.

Continuing to refer to FIG. 5, in some embodiments, when the total number of frames is greater than the total-frame-number threshold, the control module 122 is further configured to, in step S203, obtain the total number of frames in the previous detection period of the current detection period, and determine it as the previous total number of frames.

The previous detection period of the current detection period refers to a detection period before the detection period in which the performance detection system is currently located, and the previous detection period has the same period duration as the current detection period.

The previous total number of frames represents the total number of broadcast signal frames received by the gateway device in the previous detection period of the current detection period. For example, it can also be obtained by obtaining the current frame number information S3 of the first broadcast signal frame received in the previous detection period and the current frame number information S4 of the last broadcast signal frame received in the previous detection period, and subtracting the current frame number information S4 of the last broadcast signal frame from the current frame number information S3 of the first broadcast signal frame to obtain the total frame number of broadcast signal frames in the previous detection period of the current detection period, that is, the previous total number of frames.

Thereafter, in step S204, the difference between the total number of frames and the previous total number of frames is determined.

For example, the difference between the total number of frames in the current detection period and the previous total number of frames in the previous detection period can be obtained by subtracting the total number of frames in the previous detection period from the total number of frames in the current detection period and taking the absolute value of the result.

Further, in step S205, the difference is compared with a difference threshold, and the performance state of the rotating device is determined based on the comparison result.

The difference threshold refers to the upper limit of the difference. Exceeding the difference threshold indicates that the performance state (such as vibration state) of the rotating device in the current detection period has changed greatly compared with the performance state (such as vibration state) of the previous detection period, and the performance state of the rotating device changes sharply.

It will be appreciated that the performance state of the rotating device may be determined to be an abnormal state only if the difference is greater than the difference threshold, for example. Alternatively, if the difference is less than or equal to the difference threshold, the performance state of the rotating device may be determined to be a slightly abnormal state; if the difference is greater than the difference threshold, the performance state of the rotating device may be determined to be a severely abnormal state It should be understood that embodiments of the present disclosure are not limited thereto.

Based on the above, in this application, when the total number of frames is greater than the total-frame-number threshold, the gateway device is set to obtain the total number of frames in the previous detection period of the current detection period and determine it as the previous total number of frames, determine a difference between the total number of frames and the previous total number of frames, compare the difference to the difference threshold and determine a performance state of the rotating device based on the comparison result, such that when the total number of frames is greater than the total-frame-number threshold (indicative of a vibration state of the rotating device above a normal level), the relationship between the total number of frames of the current detection period (the vibration state of the current detection period) and the total number of frames of the previous detection period (the vibration state of the previous detection period) can be further judged to judge the performance state of the rotating device. This makes the performance determination take into account the performance of the rotating device in the current period and the performance difference of the rotating device between consecutive periods, thus making the detection result more reliable and robust.

With continued reference to FIG. 5, in some embodiments, the process of determining the performance state of the rotating device based on the comparison results may be described in more detail, for example. The control module 122 is, for example, configured to determine the performance state of the rotating device as a slightly abnormal state if the difference is less than or equal to the difference threshold, and determine the performance state of the rotating device as a severely abnormal state if the difference is greater than the difference threshold.

It should be understood that the slightly abnormal state means that the performance state of the rotating device is abnormal and operates stably at a uniform level of performance for a long time. For example, the vibration state characterizing the rotating device is maintained at a higher vibration state for two consecutive detection periods.

The severely abnormal state indicates that the performance state of the rotating device is abnormal and continuously suddenly changes in a short period of time, and the performance state is in an abnormal and unstable state. For example, the vibration state characterizing the rotating device is at a higher vibration state during the current detection period and has a larger sudden change compared to the previous detection period.

Based on the above, in this application, the gateway device is set to determine the performance state of the rotating device as a slightly abnormal state if the difference is less than or equal to the difference threshold, determine the performance state of the rotating device as a severely abnormal state if the difference is greater than the difference threshold, so that the current performance and global performance can be further considered to distinguish and judge the performance state of the rotating device in a finer granularity, thereby facilitating users to adopt different processing methods based on different abnormal states and improving the efficiency of abnormal response.

In some embodiments, the total-frame-number threshold and the difference threshold are automatically generated based on a machine learning process.

For example, for each of different types of rotating device, a large amount of raw data can be input into the automatic parameter learning neural network, and the automatic parameter learning neural network will continuously collect broadcast signal frames in multiple detection periods based on the large amount of raw data corresponding to the specific type of rotating device, determine the average value of the total number of broadcast signal frames collected in the multiple periods, and use the average value as the total-frame-number threshold. In addition, the automatic parameter learning neural network is further configured to calculate the differences between the total numbers of frames corresponding to every two adjacent periods in multiple consecutive periods based on the total number of frames in multiple consecutive periods, and use the average of the differences as the difference threshold.

However, it should be understood that the above only gives an example of automatically generating the total-frame-number threshold and the difference threshold based on a machine learning process. According to actual needs, neural networks can also be applied to calculate and generate the total-frame-number threshold and the difference threshold using different algorithms and other methods, and the embodiments of the present disclosure are not limited thereto.

Based on the above, in this application, by setting the total-frame-number threshold and the difference threshold to be automatically generated based on the machine learning process, the total-frame-number threshold and the difference threshold can be determined in a simple and convenient manner. In addition, through big data machine learning, on the one hand, the set total-frame-number threshold and the difference threshold have higher accuracy thereby improving the reliability of the performance detection system; on the other hand, it enables neural network-based processing for multiple different types of rotating device to generate a total-frame-number threshold and a difference threshold that are adapted to the type of rotating device, thereby expanding the usage scenarios and application objects of the performance detection system.

In some embodiments, the performance detection system 100 further includes an external device, and the external device includes at least one of the cloud platform 130 and the user device 140.

The gateway device 120 is further configured to transmit the performance state of the rotating device to the external device, and the external device is configured to receive the performance state from the rotating device and perform a corresponding operation based on the performance state of the rotating device.

For example, the external device may be configured to display or store the performance state of the rotating device. Or when the performance state of the rotating device is a slightly abnormal state or a severely abnormal state, the external device may, for example, perform corresponding alarm process and perform corresponding operation processing. For example, continuous monitoring is performed in slightly abnormal conditions, and immediate shutdown and maintenance are performed in severely abnormal conditions.

It should be understood that the above only gives an example in which an external device performs corresponding operations based on the performance state of the rotating device, and embodiments of the present disclosure are not limited thereto.

By arranging that the system further comprises an external device including at least one of a cloud platform and a user device, and arranging that the external device is configured to receive the performance state from the rotating device and perform a corresponding operation based on the performance state of the rotating device, it enables the performance detection system to flexibly transmit the determined performance state of the rotating device to the client (user device) or upload it to the cloud for backup, and perform corresponding processing based on the performance state.

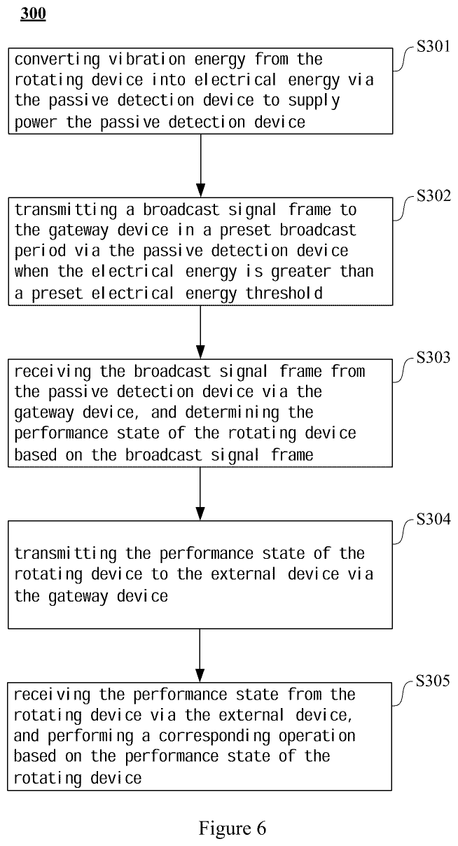

According to another aspect of the present disclosure, a performance detection method for the rotating device is proposed. FIG. 6 shows an exemplary flowchart of a performance detection method 300 for the rotating device according to an embodiment of the present disclosure.

Referring to FIG. 6, the performance detection method includes: first, in step S301, converting vibration energy from the rotating device into electrical energy via the passive detection device to supply power to the passive detection device.

The passive detection device 110 refers to a detection device that can achieve good self-power through energy conversion without additional external power supply. For example, the passive detection device 110 is configured to convert vibration energy from a rotating device into electrical energy to power the passive detection device.

It should be understood that the passive detection device may, for example, first convert vibration energy into alternating current electrical energy, and then further convert the alternating current electrical energy into direct current electrical energy. Therefore, the preset electrical energy may, for example, be a preset direct current electrical energy. However, it should be understood that embodiments of the present disclosure are not limited thereto.

In step S302, when the electrical energy is greater than a preset electrical energy threshold, a broadcast signal frame is sent to the gateway device via the passive detection device in the preset broadcast period.

By transmitting, via the passive detection device 110, broadcast signal frames to the gateway device in a preset broadcast period when the electrical energy is greater than a preset electrical energy threshold, the number of broadcast signal frames sent by the passive detection device is positively correlated with the electrical energy converted by the passive detection device, that is, positively correlated with the vibration energy of the rotating device (which reflects the current vibration state of the rotating device), thereby enabling the performance state of the rotating device to be determined based on the processing of the broadcast signal frame.

It should be understood that the preset electrical energy threshold may be, for example, set by the user, or may also be a parameter value preset by the system. Embodiments of the present disclosure are not limited thereto.

The passive detection device 110 may, for example, transmit the broadcast signal frame to the gateway device 120 via a short-range wireless communication method, such as communicating with the gateway via a short-range low-power method such as BLE, Sub G, LoRa, ZigBee, etc. It should be understood that embodiments of the present disclosure are not limited by the specific communication method.

Furthermore, the passive detection device 110 may communicate with the gateway device, for example by broadcasting. The preset broadcast period refers to a preset period in which the passive detection device transmits broadcast information. For example, in the broadcast communication mode, in order to avoid communication conflicts, the preset broadcast period may be, for example, a constant period value superimposed with a delay value floating within a preset range to improve the transmission and reception reliability of broadcast communications. However, it should be understood that embodiments of the present disclosure are not limited thereto.

The broadcast signal frame characterizes data information sent by the passive detection device 110 to the gateway device 120. For example, the broadcast signal frame may have a preset frame format. For example, the broadcast signal frame may be set to have an ID field and a frame number value field. The identifier information of the passive detection device is stored in the ID field, and the current frame number information is stored in the frame number value field. However, it should be understood that embodiments of the present disclosure are not limited thereto.

It should be understood that the above steps S301 and S302 can be performed sequentially or in parallel, and the embodiments of the present disclosure are not limited by the specific execution timing of steps S301 and S302.

Thereafter, in step S303, a broadcast signal frame is received from the passive detection device via the gateway device, and the performance state of the rotating device is determined based on the broadcast signal frame.

It will be appreciated that the gateway device may, for example, be configured to integrate a plurality of broadcast signal frames from the passive detection device 110 and determine the performance state of the rotating device based on the results of the processing.

Based on the above, in this application, by setting the performance detection method for the rotating device so that the passive detection device converts vibration energy from the rotating device into electrical energy to provide power to the passive detection device, thus the detection device in the performance detection system used in the method in this application does not need complicated wiring to achieve power supply, nor does it need to consider the problem of battery exhaustion and replacement, thereby achieving self-power in a simple and convenient manner through energy conversion and simplifying the overall settings of the performance detection system. In addition, by transmitting a broadcast signal frame to the gateway apparatus in a preset broadcast period when the electrical energy is larger than a preset electrical energy threshold so that the number of broadcast signal frames sent by the passive detection device is positively correlated with the electrical energy (that is, correlated with the vibration state of the rotating device) converted by the passive detection device, and by further receiving via the gateway device, the broadcast signal frames from the passive detection device and determining the performance state of the rotating device based on the broadcast signal frames, the performance state detection of the rotating device can be realized in a simple and convenient manner through the cooperation of the passive detection device and the gateway device. There is no need to set up a separate dedicated detection sensor or sensing circuit. It takes into account the performance detection of the rotating device while realizing the self-power supply of the detection device, further simplifies the system structure, and improves the reliability and robustness of the performance detection system.

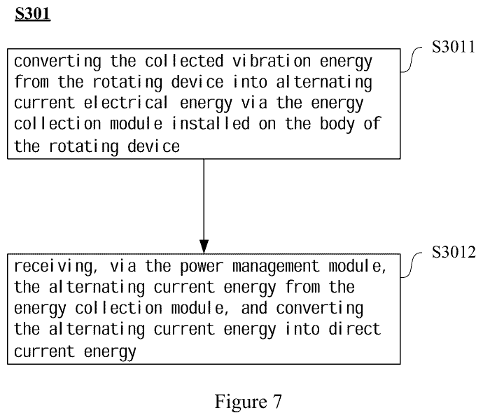

FIG. 7 illustrates an exemplary flowchart of a process S301 of converting vibration energy from a rotating device into electrical energy, in accordance with an embodiment of the present disclosure. Referring to FIG. 7, in some embodiments, the above-mentioned process S301 of converting vibration energy from the rotating device into electrical energy via a passive detection device to power the passive detection device may be described in more detail, for example.

For example, the process of converting vibration energy from the rotating device into electrical energy via the passive detection device 110 to power the passive detection device 110 may include: in step S3011, converting the collected vibration energy from the rotating device into alternating current electrical energy via the energy collection module 111 installed on the body of the rotating device; in step S3012, receiving the alternating current energy from the energy collection module via the power management module 112, and converting the alternating current energy into direct current energy.

The energy collection module 111 is intended to realize the conversion process of vibration energy into electrical energy. For example, the energy collection module 111 may be installed, for example, on the body of the rotating device and configured to convert the collected vibration energy from the rotating device into the alternating current energy.

For example, when the rotating device is a motor, the energy collection module 111 can be installed on the bearing bracket of the main shaft of the motor, or at the heat sink of the motor, to better collect the vibration energy of the motor.

For example, the energy collection module may be, for example, a piezoelectric transducer, a magnetoelectric transducer, or a triboelectric transducer to convert vibration energy from the rotating device into alternating current energy based on piezoelectric/magnetoelectric/triboelectric conversion.

However, it should be understood that depending on the actual situation, other structures, components or types of transducers may be selected to achieve the conversion of vibration energy into alternating current energy. It should be understood that the embodiments of the present disclosure are not limited by the specific energy conversion method and the specific type of transduction component.

It should be understood that the power management module 112 may, for example, rectify the alternating current energy obtained in the energy collection module based on a rectifier module to obtain direct current energy. The power management module can also be further provided with, for example, a regulator module, an energy tracking module, etc., to achieve further adjustment of the direct current energy and maximize the obtained electric power.

Based on the above, in this application, the passive detection device can be well self-powered by converting the collected vibration energy from the rotating device into the alternating current energy via the energy collection module, and converting the alternating current energy into the direct current energy via the power management module.

In some embodiments, when the electrical energy is greater than the preset electrical energy threshold, the process S302 of transmitting broadcast signal frames to the gateway device in a preset broadcast period via the passive detection device may be described in more detail. For example, the process may include: Transmit broadcast signal frames in a preset broadcast period via the powered-on communication module 113.

If the direct current energy is greater than the preset direct current energy threshold, the power is supplied to the communication module 113 via the power management module 112. If the direct current energy is lower than the preset direct current energy threshold, the communication module 113 is powered off via the power management module 112. The preset direct current energy threshold represents a minimum direct current energy value that enables a good power supply to the communication module. It should be understood that the preset direct current energy threshold may be, for example, selected by a user, or may also be preset, and embodiments of the present disclosure are not limited thereto.

For example, if the preset direct current energy threshold is A, when the performance detection method is executed, the energy collection unit provided on the main body of the rotating device will continue to convert the vibration energy into the alternating current energy, and the alternating current energy is further converted into the direct current energy in the power management module. If the direct current energy Wc is greater than the preset direct current energy threshold A, the power management module will supply power to the communication module at this time. For example, the communication module transmits broadcast signal frames in a broadcast period Tc. For example, after transmitting 20 broadcast signal frames, the direct current energy Wc is less than the direct current energy threshold A, then the communication module will be powered off at this time, and the communication module will no longer transmit broadcast signal frames until the next direct current energy Wc meets the condition that it is greater than the preset direct current energy threshold A, and the communication module will be powered on again.

As described in detail above with reference to FIG. 2, the energy collection module 111, the power management module 112 and the communication module 113 can be integrated into the passive detection device 110, for example.

By setting that the communication module is powered on when the direct current electrical energy is greater than the preset direct current electrical energy threshold and the communication module is powered off when the direct current electrical energy is lower than the preset direct current electrical energy threshold, and the communication module is allowed to transmit broadcast signal frames in a preset broadcast period after being powered on, so that the communication module can be powered on when the power reaches a predetermined level and the communication module transmits a corresponding broadcast signal frame, thereby facilitating subsequent determination of the performance state of the rotating device based on the broadcast signal frame.

In some embodiments, as mentioned before, the broadcast signal frame includes identifier information of the passive detection device and current frame number information.

The identifier information of the passive detection device 110 refers to information used to represent the passive detection device, which may be, for example, a universal Unique Identifier (UUID) of the passive detection device, or may also be other identifiers characterizing the passive detection device. Embodiments of the present disclosure are not limited by the composition of the identifier information.

By transmitting the identifier information of the passive detection device in the broadcast signal frame, when there are multiple passive detection devices (for example, respectively detecting the performance state of different rotating devices), the passive detection device and the corresponding rotating device which correspond to the currently received broadcast signal frame can be determined simply and conveniently.

The current frame number information is intended to represent the total number of currently sent broadcast signal frames. The current frame number information may be, for example, in the form of 10-bit binary encoding, or may also be in other forms. Embodiments of the present disclosure are not limited thereto. The current frame number information increases with the increase of the transmission times of the broadcast signal frame.

It should be understood that, according to actual needs, the broadcast signal frame may also have, for example, encrypted verification information, which is obtained by processing core data (such as current frame number information) with a specific verification algorithm. At this time, after the gateway device receives the core data, for example, the core data will be calculated through the same verification algorithm to obtain new encrypted verification information, and the new encrypted verification information will be compared with the encrypted verification information contained in the broadcast signal frame to avoid the situation where the broadcast signal frame is changed by interference or attacks during transmission.

Based on the above, in this application, by setting the broadcast signal frame to include the identifier information of the passive detection device and the current frame number information, and setting the current frame number information to increase with the increase of the transmission times of the broadcast signal frame, the passive detection device that sent the broadcast signal frame can be reliably determined based on the broadcast signal frame, and at the same time, the total number of broadcast signal frames that has been sent at present (current frame number information) can be determined, so that subsequent processing can be well performed based on the current frame number information to determine the performance state of the corresponding rotating device.

In some embodiments, at least part of the content in the broadcast signal frame is encrypted, and the gateway device performs corresponding decryption processing after receiving the broadcast signal frame.

It should be understood that the encryption process may be, for example, an encryption process by appending an additional encryption check field as described above, or it may also be to encrypt the entire broadcast signal frame and then transmit the encrypted data content. It should be understood that the embodiments of the present disclosure are not limited by the encryption process and encryption method.

Based on the above, in this application, at least part of the content in the broadcast signal frame is encrypted, and the gateway device performs corresponding decryption processing after receiving the broadcast signal frame, so that the reliability and security of the communication transmission can be further improved on the basis of realizing good communication.

In some embodiments, the process S303 of receiving a broadcast signal frame from the passive detection device via a gateway device and determining a performance state of the rotating device based on the broadcast signal frame can be described in more detail, for example.

For example, first, a broadcast signal frame from the passive detection device 110 is received via the wireless communication module 121.

It should be understood that the wireless communication module 121 may, for example, have multiple channels to simultaneously receive broadcast signal frames from multiple passive detection devices.

Thereafter, the performance state of the rotating device is determined based on the broadcast signal frame via the control module 122. For example, the control module 122 may determine the total number of frames in the current detection period based on the broadcast signal frame, compare the total number of frames to a total-frame-number threshold and determine the performance state of the rotating device based on the comparison. However, it should be understood that the above only gives an example, and embodiments of the present disclosure are not limited thereto.

It should be understood that, as mentioned above, the wireless communication module 121 and the control module 122 may be integrated into the gateway device 120, for example. According to actual needs, the gateway device 120 may further include, for example, an Internet communication module 123, a power management module 124, a Human Machine Interface (HMI) and input/output (I/O) interface module 125, and its related functions are as mentioned above, they will not be described again here.

Based on the above, in this application, by setting the broadcast signal frame from the passive detection device to be received via the wireless communication module, and determining the performance state of the rotating device based on the broadcast signal frame via the control module, each functional module within the gateway device can be well set, thereby optimizing the functional layout of the gateway device and achieving good performance detection of the rotating device.

In some embodiments, referring to the aforementioned FIG. 5, the process of determining the performance state of the rotating device based on the broadcast signal frame via the control module 122 may be described in more detail. For example, first, in step S201, based on the broadcast signal frame, the total number of frames in the current detection period is determined.

The detection period refers to the period of detecting the rotating device, and the current detection period is the detection period in which the performance detection method is currently located. For example, it can be preset or selected by the user.

It should be understood that the duration of the current detection period is greater than the duration of the preset broadcast period. For example, the duration of the current detection period is usually in units of hours, and the duration of the preset broadcast period is usually in units of ms.

Thereafter, in step S202, the total number of frames is compared with a total-frame-number threshold, and if the total number of frames is less than or equal to the total-frame-number threshold, the performance state of the rotating device is determined to be a normal state.

The total-frame-number threshold refers to a data value used to represent the upper limit of the total number of frames. Exceeding the threshold reflects that there are too many broadcast signal frames in the current detection period, because the number of broadcast signal frames is strongly related to the vibration state (vibration amplitude, vibration intensity and vibration frequency) of the rotating device, that is, it reflects that the vibration state of the rotating device is abnormal in the current detection period.

It should be understood that the total-frame-number threshold may be preset, for example, or may be selected by the user, or may be automatically generated via machine learning, such as by a neural network algorithm. Embodiments of the present disclosure are not limited thereto.

The normal state means that the rotating device is in a normal operating and working state. For example, it can indicate that the vibration state of the rotating device is within a preset range and does not affect the normal use of the rotating device.

Based on the above, in this application, by determining the total number of frames in the current detection period based on the broadcast signal frame, and comparing the total number of frames with a total-frame-number threshold, determining the performance state of the rotating device as a normal state if the total number of frames is less than or equal to the total-frame-number threshold, the performance state of the rotating device can be determined in a simple and convenient manner based on broadcast signal frames.

Continuing to refer to FIG. 5, in some embodiments, when the total number of frames is greater than the total-frame-number threshold, the process of determining, via the control module 122, the performance state of the rotating device based on the broadcast signal frame further include, in step S203, obtaining the total number of frames in the previous detection period of the current detection period, and determining it as the previous total number of frames.

The previous detection period of the current detection period refers to a detection period before the detection period in which the performance detection method is currently performing, and the previous detection period has the same period duration as the current detection period. The previous total number of frames represents the total number of broadcast signal frames received by the gateway device in the previous detection period of the current detection period.

Thereafter, in step S204, the difference between the total number of frames and the previous total number of frames is determined.

For example, the difference between the total number of frames in the current detection period and the previous total number of frames in the previous detection period can be obtained by subtracting the total number of frames in the previous detection period from the total number of frames in the current detection period and taking the absolute value of the result.

Further, in step S205, the difference is compared with a difference threshold, and the performance state of the rotating device is determined based on the comparison result.

The difference threshold refers to the upper limit of the difference. Exceeding the difference threshold indicates that the performance state (such as vibration state) of the rotating device in the current detection period has changed greatly compared with the performance state (such as vibration state) of the previous detection period, and the performance state of rotating device changes sharply.

Based on the above, in this application, when the total number of frames is greater than the total-frame-number threshold, by obtaining the total number of frames in the previous detection period of the current detection period and determining it as the previous total number of frames, determining a difference between the total number of frames and the previous total number of frames and comparing the difference to the difference threshold and determine a performance state of the rotating device based on the comparison result, when the total number of frames is greater than the total-frame-number threshold (indicative of a vibration state of the rotating device above a normal level), the relationship between the total number of frames of the current detection period (the vibration state of the current detection period) and the total number of frames of the previous detection period (the vibration state of the previous detection period) can be further judged to judge the performance state of the rotating device. This makes the performance determination take into account the performance of the rotating device in the current period and the performance difference of the rotating device between consecutive periods, thus making the detection result more reliable and robust.

With continued reference to FIG. 5, in some embodiments, the process S205 of determining the performance state of the rotating device based on the comparison results may be described in more detail. If the difference is less than or equal to the difference threshold, the performance state of the rotating device is determined as a slightly abnormal state; and if the difference is greater than the difference threshold, the performance state of the rotating device is determined as a severely abnormal state.

It should be understood that the slightly abnormal state means that the performance state of the rotating device is abnormal and operates stably at a uniform level of performance for a long time. For example, the vibration state characterizing the rotating device is maintained at a higher vibration state for two consecutive detection periods.

The severely abnormal state indicates that the performance state of the rotating device is abnormal and continuously suddenly changes in a short period of time, and the performance state is in an abnormal and unstable state. For example, the vibration state characterizing the rotating device is at a higher vibration state during the current detection period and has a larger sudden change compared to the previous detection period.

Based on the above, in this application, it determines the performance state of the rotating device as a slightly abnormal state if the difference is less than or equal to the difference threshold, determines the performance state of the rotating device as a severely abnormal state if the difference is greater than the difference threshold, so that the current performance and global performance can be further considered to distinguish and judge the performance state of the rotating device in a finer granularity, thereby facilitating users to adopt different processing methods based on different abnormal states and improving the efficiency of abnormal response.

In some embodiments, the total-frame-number threshold and the difference threshold are automatically generated based on a machine learning process.

However, it should be understood that, according to actual needs, neural networks can also be applied to calculate and generate the total-frame-number threshold and the difference threshold using different algorithms and other methods, and the embodiments of the present disclosure are not limited thereto.

Based on the above, in this application, by setting the total-frame-number threshold and the difference threshold to be automatically generated based on the machine learning process, the total-frame-number threshold and the difference threshold can be determined in a simple and convenient manner. In addition, by big data machine learning, on the one hand, the set total-frame-number threshold and the difference threshold have higher accuracy thereby improving the reliability of the performance detection system; on the other hand, it enables neural network-based processing for multiple different types of rotating device to generate a total-frame-number threshold and a difference threshold that are adapted to the type of rotating device, thereby expanding the usage scenarios and application objects of the

In some embodiments, referring to FIG. 6, the performance detection method 300 further includes: in step S304, transmitting the performance state of the rotating device to the external device via the gateway device; and in step S305, receiving the performance state from the rotating device via the external device, and performing a corresponding operation based on the performance state of the rotating device.

The external device includes, for example, at least one of the aforementioned cloud platform 130 and the user device 140.

For example, the external device may display or store the performance state of the rotating device. Or, when the performance state of the rotating device is a slightly abnormal state or a severely abnormal state, the external device may, for example, perform a corresponding alarm process, and perform corresponding operation processing. For example, continuous monitoring is performed in slightly abnormal conditions, and immediate shutdown and maintenance are performed in severely abnormal conditions.

It should be understood that the above only gives an example in which an external device performs corresponding operations based on the performance state of the rotating device, and embodiments of the present disclosure are not limited thereto.

By receiving the performance state from the rotating device via an external device and performing corresponding operations based on the performance state of the rotating device, the performance detection method can flexibly transmit the determined performance state of the rotating device to the client (user device) or upload it to the cloud for backup, and perform corresponding processing based on the performance state.

The present application uses specific words to describe embodiments of the present application. For example, “a first/second embodiment”, “an embodiment”, and/or “some embodiments” means a certain feature, structure or characteristic related to at least one embodiment of the present application. Therefore, it should be emphasized and noted that “one embodiment” or “an embodiment” or “an alternative embodiment” mentioned twice or more in different places in this specification do not necessarily refer to the same embodiment. In addition, certain features, structures or characteristics in one or more embodiments of the present application may be combined appropriately.

Moreover, those skilled in the art will appreciate that aspects of the present application may be illustrated and described in terms of several patentable categories or circumstances, including any new and useful process, machine, product, or combination of matter, or any new and useful improvement thereof. Accordingly, various aspects of the present application can be executed entirely by hardware, entirely by software (including firmware, resident software, microcode, etc.), or by a combination of hardware and software. The above hardware or software may be referred to as a “data block”, “module”, “engine”, “unit”, “component” or “system”. Additionally, aspects of the present application may be embodied as a computer product including computer-readable program code located on one or more computer-readable media.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The foregoing is illustrative of the present disclosure and is not to be construed as limiting thereof. Although several exemplary embodiments of this present disclosure have been described, those skilled in the art will readily appreciate that many modifications are possible in the exemplary embodiments without departing from the novel teachings and advantages of this present disclosure. Accordingly, all such modifications are intended to be included within the scope of this present disclosure as defined in the claims. It is to be understood that the foregoing is illustrative of the present disclosure and is not to be considered limited to the specific embodiments disclosed, and that modifications to the disclosed embodiments, as well as other embodiments, are intended to be included within the scope of the appended claims. The present disclosure is defined by the claims and their equivalents.

What is claimed is:

1. A performance detection system for a rotating device, the performance detection system comprising:
a gateway device; and
a passive detection device configured to convert vibration energy from the rotating device into electrical energy to supply power to the passive detection device, the passive detection device being configured to transmit a broadcast signal frame to the gateway device in a preset broadcast period when the electrical energy is greater than a preset electrical energy threshold;
the gateway device being configured to receive the broadcast signal frame from the passive detection device and determine a performance state of the rotating device based on the broadcast signal frame.

2. The performance detection system of claim 1, wherein the passive sensing device comprises:
an energy collection module installed on a body of the rotating device and configured to convert the collected vibration energy from the rotating device into alternating current energy;
a power management module configured to receive the alternating current energy from the energy collection module and convert the alternating current energy to direct current energy; and
a communication module configured to transmit the broadcast signal frame in the preset broadcast period after being powered on;
wherein the power management module is configured to:
supply power to the communication module when the direct current energy is greater than a preset direct current energy threshold; and
cause the communication module to power off when the direct current energy is lower than the preset direct current energy threshold.

3. The performance detection system of claim 1,
wherein the broadcast signal frame includes identifier information of the passive detection device and current frame number information; and
wherein the current frame number information increases as the transmission times of the broadcast signal frame increase.

4. The performance detection system of claim 1, wherein at least part of the content in the broadcast signal frame is encrypted, and the gateway device receives the broadcast signal frame and performs corresponding decryption processing after receiving the broadcast signal frame.

5. The performance detection system of claim 1, wherein the gateway device comprises:
a wireless communication module configured to receive the broadcast signal frame from the passive detection device; and
a control module configured to determine the performance state of the rotating device based on the broadcast signal frame.

6. The performance detection system of claim 5, wherein the control module is configured to:
determine a total number of frames in a current detection period based on the broadcast signal frame, wherein a duration of the current detection period is greater than a duration of the preset broadcast period; and
compare the total number of frames to a total-frame-number threshold, and determine the performance state of the rotating device to be a normal state if the total number of frames is less than or equal to the total-frame-number threshold.

7. The performance detection system of claim 6, wherein, in a case that the total number of frames is greater than the total-frame-number threshold, the control module is further configured to:
obtain a total number of frames of a detection period immediately preceding the current detection period and determine it as a previous total number of frames;
determine a difference between the total number of frames and the previous total number of frames; and
compare the difference to a difference threshold and determine the performance state of the rotating device based on the comparison.

8. The performance detection system of claim 7, wherein the control module is configured to:
determining the performance state of the rotating device as a slightly abnormal state if the difference is less than or equal to the difference threshold;
determining the performance state of the rotating device as a severely abnormal state if the difference is greater than the difference threshold.

9. The performance detection system of claim 8, wherein the total-frame-number threshold and the difference threshold are automatically generated based on a machine learning process.

10. The performance detection system of claim 1, wherein the system further comprises an external device, the external device comprising at least one of a cloud platform and a user device;
wherein the gateway device is further configured to transmit the performance state of the rotating device to the external device, and the external device is configured to receive the performance state from the rotating device and perform a corresponding operation based on the performance state of the rotating device.

11. A performance detection method for a rotating device, the method comprising:
converting, via a passive detection device, vibration energy from the rotating device into electrical energy to supply power to the passive detection device;
transmitting, via the passive detection device, a broadcast signal frame to a gateway device in a preset broadcast period when the electrical energy is greater than a preset electrical energy threshold; and
receiving, via the gateway device, the broadcast signal frame from the passive detection device and determining a performance state of the rotating device based on the broadcast signal frame.

12. The performance detection method of claim 11 wherein converting the vibration energy from the rotating device into the electrical energy via the passive detection device to supply power to the passive detection device comprises:
converting, via an energy collection module installed on a body of the rotating device, the collected vibration energy from the rotating device into alternating current energy;
receiving, via a power management module, the alternating current energy from the energy collection module and converting the alternating current energy into direct current energy.

13. The performance detection method of claim 12, wherein transmitting the broadcast signal frame via the passive detection device to the gateway device in the preset broadcast period when the electrical energy is greater than the preset electrical energy threshold comprises: transmitting the broadcast signal frame, via a communication module being powered on, in the preset broadcast period; and
wherein the communication module is powered on, via the power management module, when the direct current energy is greater than a preset direct current energy threshold; the communication module is powered off, via the power management module, when the direct current energy is lower than the preset direct current energy threshold.
